(19) United States
(12) Patent Application Publication
(10) Pub. No.: US 2008/0153520 A1
(43) Pub. Date: Jun. 26, 2008

(54) Targeted short messaging service advertisements

(75) Inventor: Prashant Kirtane, The Harbourlights (SG)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/643,085

(22) Filed: Dec. 21, 2006

(51) Int. Cl. H04Q 7/20; G06Q 30/00

(52) U.S. Cl. 455/466; 705/14

(57) ABSTRACT

The present embodiments relate to a system and/or method for adding targeted advertisements to messages. An analysis of a variety of parameters may be used to select and display a targeted advertisement to a user. The targeted advertisement is displayed in a message to the user. In one example, the message may be a short messaging service (SMS) message that includes the targeted advertisement.

### BACKGROUND

Online advertising may be an important source of revenue for enterprises engaged in electronic commerce. A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement. An advertisement may be selected and added to the page based on a number of factors for targeting the advertisement to the user.

As technology becomes more mobile and devices such as mobile/cellular phones become more common, new communication means are evolving. For example, it is becoming more common to communicate through text messaging. Text messaging provides a quick and convenient way to communicate. In one example, the short messaging service (SMS) may be used to send messages between users of mobile devices. Further, SMS is being incorporated in devices other than mobile phones. For example, various websites allow for the composition and sending of an SMS message to other users.

As a result of this increased popularity, it may be advantageous to develop advertising that may be integrated into SMS. Advertising based on SMS messages may generate significant revenue based on the popularity and the large number of SMS messages that are transmitted daily. However, SMS based advertising should be incorporated into the SMS messages in such a way that the user will view the advertisement and consider the product or service that is being advertised without being overly burdened by the advertisement.

### BRIEF DESCRIPTION OF THE DRAWINGS

The system and/or method may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views.

FIG. 1 is a view of an operating environment according to one embodiment;

FIG. 2 is a view of an operating environment according to another embodiment;

FIG. 3 is a flow diagram of an embodiment for transmitting a message;

FIG. 4 is a flow diagram of an embodiment for selecting an advertisement;

FIG. 5 depicts exemplary factors 501 which may be used for advertisement selection;

FIG. 6 illustrates one embodiment of a message and targeted advertisement;

FIG. 7 illustrates another embodiment of a message and targeted advertisement;

FIG. 8 illustrates another embodiment of a message and targeted advertisement;

FIG. 9 illustrates another embodiment of a message and targeted advertisement; and

FIG. 10 is an illustration a general computer system.

### DETAILED DESCRIPTION

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims and be defined by the following claims. Nothing in this section should be taken as a limitation on those claims. Further aspects and advantages are discussed below in conjunction with the embodiments.

By way of introduction, the embodiments described below include a system and method for including targeted advertising in messages. The embodiments relate to an analysis of a variety of factors or parameters to select and display a targeted advertisement to a user based on those factors. The targeted advertisement is displayed in a message to the user. In one embodiment, the message may be a short messaging service (SMS) message that has been augmented to include the targeted advertisement.

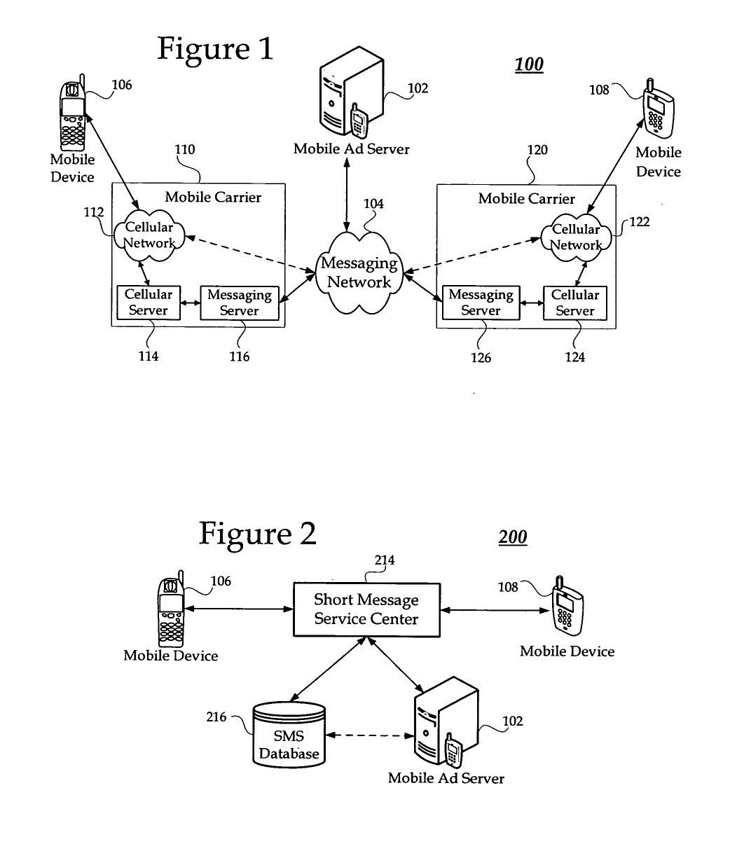

FIG. 1 provides a simplified view of an operating environment 100 according to one embodiment. Not all of the depicted components may be required, however, and some embodiments may include additional components not shown in the figure. Variations in the arrangement and type of the components may be made without departing from the spirit or scope of the claims as set forth herein. Additional, different or fewer components may be provided.

The operating environment 100 includes a mobile advertisement server (mobile ad server) 102 coupled with a network 104. An exemplary mobile device 106 is coupled with a mobile carrier 110, which is coupled with the network 104. Another exemplary mobile device 108 is coupled with a mobile carrier 112, which is also coupled with the network 104. Herein, the phrase “coupled with” is defined to mean directly connected to or indirectly connected through one or more intermediate components. Such intermediate components may include both hardware and software based components.

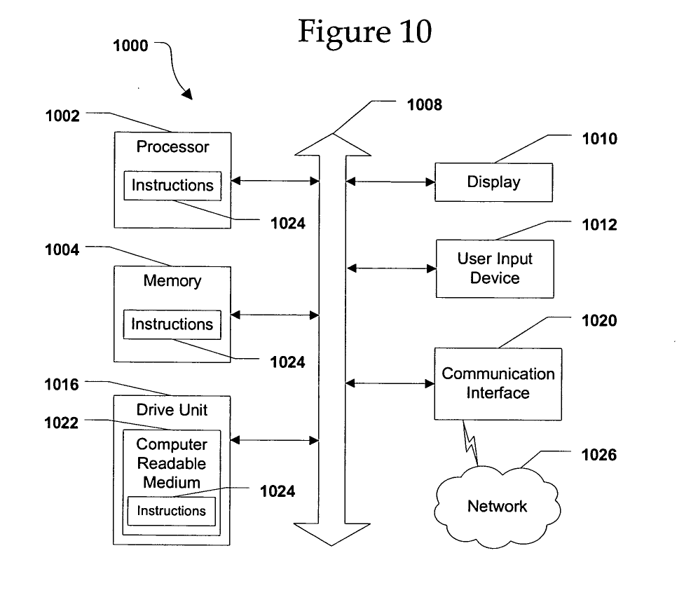

The mobile ad server 102 may provide advertisements that may be included in a message being conveyed between mobile devices 106, 108 or the users thereof. The mobile ad server 102 is coupled with the network 104 to receive information about a message being conveyed and transmit a targeted advertisement to be included with that message. In one embodiment, the mobile ad server 102 may be coupled directly with the mobile carriers 110, 112 to provide targeted advertisements. The mobile ad server 102 may include a database (not shown) with parameters or factors about various users that may be used in selecting a targeted advertisement, as well as the available advertisements that may be used. The mobile ad server 102 may select advertisements based on any of the factors. Regardless of how the advertisements are selected, the mobile ad server 102 may provide advertisements to be included with the messages. In one embodiment, the mobile ad server 102 may comprise a general computer system or any of the components as described below in FIG. 10.

The messaging network 104 may generally be enabled to employ any form of machine-comprehensible media for communicating information, such as messages, from one device to another and may include any communication method by which information may travel between devices. The messaging network 104 may be a network 1026 as described in FIG. 10. For example, the messaging network 104 may include one or more of a wireless network, a wired network, a local area network (LAN), a wide area network (WAN), a direct connection such as through a Universal Serial Bus (USB) port, and the like, and may include the set of interconnected networks that make up the Internet. The wireless network may be a cellular telephone network, a network operating according to a standardized protocol such as IEEE 802.11, 802.16, 802.20, published by the Institute of Electrical and Electronics Engineers, Inc., or WiMax network. Further, the messaging network 104 may be a public network, such as the Internet, a private network, such as an intranet, or combinations thereof, and may utilize a variety of networking protocols now available or later developed including, but not limited to TCP/IP based networking protocols. Any of the components in environment 100 may be coupled with one another through other networks in addition to messaging network 104. In one embodiment, the messaging network 104 may be an SMS network that is configured to receive and transmit SMS messages.

In one embodiment, the exemplary mobile devices 106, 108 allow users to communicate with one another, such as by voice and/or the exchange of electronic messages as will be described. The mobile devices 106, 108 may be any devices that a user utilizes to connect with other users/devices, mobile or non-mobile. Exemplary mobile devices 106, 108 include cellular telephones, cellular modems, radio pagers, WiFi or Cellular enabled PDA's, packet radios, etc. It will be appreciated that other non-mobile devices may be used to communicate as described, in addition to or instead of one or more of the mobile device 106, 108. Exemplary non-mobile devices include a website on a desktop computer that may allow a user to send a message to another device. Likewise, other non-mobile devices may include a conventional personal computer, network-enabled television, digital video recorder, such as TIVO®, and/or automobile.

A user may not only include any individual, but a business entity or group of people. Any user may utilize a device such as mobile device 106 or 108, which may be any mobile user device, including a network-enabled mobile phone, voice over IP (VoIP) phone, cellular phone, personal digital assistant (PDA), pager. The mobile devices 106, 108 are configured to connect with the messaging network 104, and may be the general computer system or any of the components as described in FIG. 10, such as the user input device 1012. In alternate embodiments, there may be additional mobile devices or non-mobile devices, and additional intermediary networks that are established to connect the users or user devices.

In one embodiment, a first user may use a mobile device 106 to communicate with a second user, who uses another mobile device 108, through messaging. For example, the mobile devices 106, 108 may be cellular phones that allow messaging. The messaging may be text messages that are sent through the short message service (SMS), which is described below in FIG. 2. Throughout this disclosure messaging may refer to store and forward based messaging systems such as SMS messaging or electronic mail or other forms of messaging, such as peer to peer based or direct messaging systems, e.g. instant messaging, or multimedia messaging. Multimedia messaging may include messages that include elements other than text, such as multimedia, including but not limited to pictures, images, audio, video, or other multimedia elements.

Mobile device 106 is coupled with mobile carrier 110, and mobile device 108 is coupled with mobile carrier 120. Mobile carrier 110 includes a cellular network 112, a cellular server 114, and a messaging server 116. Likewise, Mobile carrier 120 includes a cellular network 122, a cellular server 124, and a messaging server 126. In one embodiment, the mobile carrier 110 is a cellular telephone company associated with the mobile device 106, such as Verizon®, Sprint® or Cingular®. Likewise, the mobile carrier 120 is also cellular telephone company associated with the mobile device 108. In that embodiment, the mobile devices 106, 108 are cellular telephones, or other compatible devices, that are coupled with cellular networks 112, 122, respectively. The cellular networks 112, 122 may be coupled with one another directly or indirectly, or may be the same network. In one embodiment, mobile carrier 110 may be the same as mobile carrier 120 in which case, the cellular network 112 may be the same as cellular network 122.

The cellular servers 114, 124 are coupled with the cellular networks 112, 122, respectively. The cellular servers 114, 124 may transmit phone calls, messages, or other data to and from mobile devices 106, 108, respectively. The transmission of phone calls, messages or other data may be over the cellular networks 112, 122. The cellular servers 114, 124 may be coupled with messaging servers 116, 126, respectively. In one embodiment, the cellular servers 114, 124 and the respective messaging servers 116, 126 may be suitably combined as a single server or otherwise tightly coupled system. The messaging servers 116, 126 are coupled with the messaging network 104 and are configured to receive and transmit messages over the messaging network 104.

In exemplary operation according to one embodiment, the user of mobile device 106 would like to send a message to the recipient of mobile device 108. The message is transmitted over the cellular network 112 to the cellular server 114 from the mobile carrier 110 associated with mobile device 106. The message is sent from mobile carrier 10's messaging server 116 over the messaging network 104. The messaging server 126 of mobile carrier 120 receives the message. The cellular server 124 passes the message over the cellular network 122 to the mobile device 108. When the message is passed over the messaging network 104, the mobile ad server 102 may attach a targeted advertisement to the message, as will be described in more detail below.

In an alternate embodiment, any of the components in environment 100 may be coupled with one another through the messaging network 104 or other networks. For example, the cellular networks 112, 122 may be combined with the messaging network 104 such that the mobile devices 106, 108 may be coupled with the cellular servers 114, 124, respectively, through the messaging network 104. In one embodiment, both mobile device 106 and mobile device 108 may be associated with the same mobile carrier, such as mobile carrier 110 or mobile carrier 120, in which case mobile devices 106, 108 are coupled with the same cellular network.

FIG. 2 provides a simplified view of an operating environment 200 according to another embodiment. The mobile device 106 and mobile device 108 are coupled with a short message service center (SMSC) 214. The SMSC 214 is coupled with a short message service (SMS) database 216 and coupled with the mobile ad server 102. Variations in the arrangement and type of the components may be made without departing from the spirit or scope of the claims as set forth herein. Additional, different or fewer components may be provided.

Any of the components in environment 200 may be coupled with one another through a network (not shown). Accordingly, any of the components in environment 200 may include communication ports configured to connect with a network. Accordingly, the present disclosure contemplates a computer-readable medium that includes instructions or receives and executes instructions responsive to a propagated signal, so that a device connected to a network can communicate voice, video, audio, images or any other data over a network. The instructions may be transmitted or received over the network via a communication port that may be a part of a processor or may be a separate component. The communication port may be created in software or may be a physical connection in hardware. The communication port may be configured to connect with a network, external media, display, or any other components in environment 200, or combinations thereof. The connection with the network may be a physical connection, such as a wired Ethernet connection or may be established wirelessly as discussed below. Likewise, the additional connections with other components of the environment 200 may be physical connections or may be established wirelessly.

The SMSC 214 may be server that allows for communication between users, such as between mobile device 106 and mobile device 108. Accordingly, the SMSC 214 may be a messaging server, such as messaging servers 116, 118, or may be another entity. In one embodiment, the SMSC 214 is a network element configured to facilitate communications in a communications network, such as a mobile telephone network. The SMSC 214 may receive a message from mobile device 106 that is intended for mobile device 108. The SMSC 214 may receive and store the message until it is transmitted to mobile device 108 when mobile device 108 is available to receive the message. If a recipient, such as mobile device 108 is unavailable, then the SMSC 214 may store the message and attempt to send the message later. The SMSC 214 may be coupled with an SMS database 216. The SMS database 216 may store the messages that are passed through the SMSC 214. Messages that are received by the SMSC 214 may be stored in the SMS database 216 until they are sent and received by the recipient.

The mobile ad server 102 may also be coupled with the SMSC 214. The mobile ad server 102 may provide an advertisement for each message that is passed through the SMSC 214. In one embodiment, a message is stored in the SMS database 216 and the mobile ad server 102 has access to that database 216 and can attach an advertisement to the stored message before the SMSC 214 transmits the message to the recipient.

In one embodiment, SMS operates on a store-and-forward basis. In one example, a user of mobile device 106 would like to send an SMS message to the recipient of mobile device 108. The SMS message from the mobile device 106 is sent to the SMSC 214. The SMSC 214 may store the SMS message in the SMS database 216. The mobile ad server 102 may add a targeted advertisement to the SMS message while it is stored in the SMS database 216. The targeted advertisement may be selected based on information about the recipient as discussed below. The recipient information may also be stored in the SMS database 216. Once the targeted advertisement is augmented to the SMS message and the mobile device 108 is available, the SMSC 214 may send the SMS message to mobile device 108.

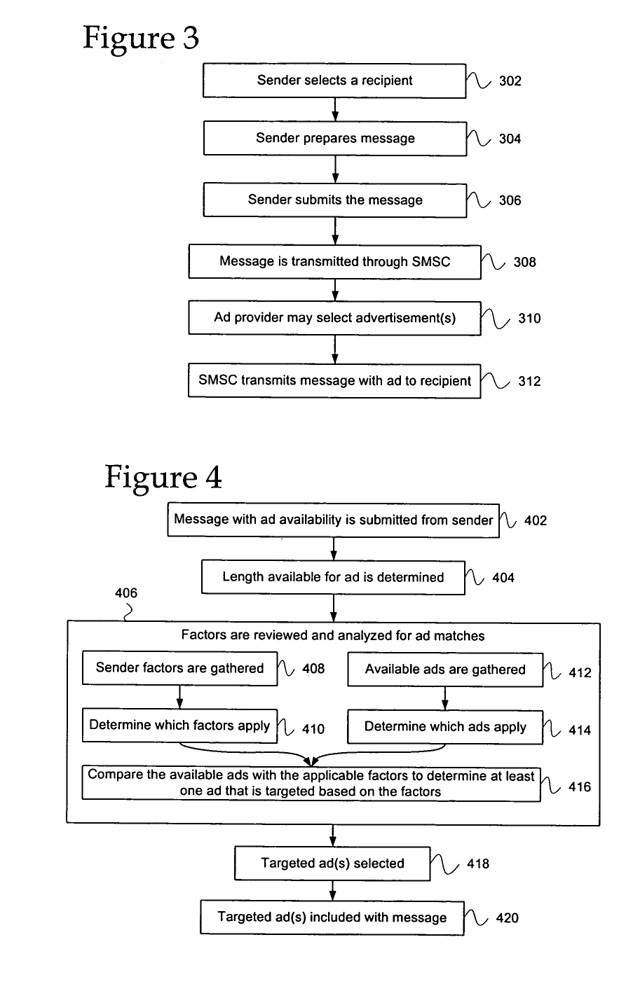

FIG. 3 is a flow diagram of a process for transmitting a message. FIG. 3 is one embodiment of a process that may be used to send a message within environment 200. In particular, a sender (who may use mobile device 106) would like to send a message to a recipient (who may use mobile device 108). In block 302, the sender selects a recipient. In one example, the sender may select the recipient from a list of contacts. In block 304, the sender prepares a message to be sent to the recipient. For example, the sender types a SMS message telling the recipient that the sender will be late for an appointment. In block 306, the sender submits the message. The submission of the message may be accomplished by pressing a send a button on mobile device 160 to indicate that the message is completed and ready for transmission to the recipient. In block 308, the message is transmitted to the SMSC 214. The SMSC 214 may temporarily store or otherwise buffer the message, such as in the SMS database 216, while determining if the recipient is available or otherwise attempting to establish communications with the recipient's mobile device 108 for purpose of delivering the message, i.e. their mobile device 108 is available to receive the message, e.g. turned on, within range, etc. While the message is temporarily stored, the SMSC 214 may notify the mobile ad server 102 of the presence of the message and include relevant information or factors about the recipient to consider in the selection of an advertisement that may be included therewith. Accordingly, in block 310, the mobile ad server 102 may select an advertisement to be included in the message. The mobile ad server 102 may access the message from the SMSC 214 or from the SMS database 216 to select the advertisement. In addition, the mobile ad server 102 may also access additional factors about the recipient which may be used in selecting the proper advertisement as discussed below. Once the advertisement is selected and attached to the message, then the SMSC transmits the message with the advertisement to the recipient.

FIG. 4 is a flow diagram of one embodiment of the operation of advertisement selection. In particular, FIG. 4 is a more detailed example of the selection of an advertisement as in block 310 of FIG. 3. In block 402, the message is submitted by the sender, as in block 306 of FIG. 3. In block 404, the length available for an advertisement is determined. In one example, SMS messages may be limited to 160 characters or some other limitation, therefore the length of the message may influence the advertisement that is displayed. In particular, if the message (without the advertisement) is 160 characters, then there are no characters for an advertisement. Conversely, if the SMS message is only 20 characters, then up to 140 characters may be used for an advertisement.

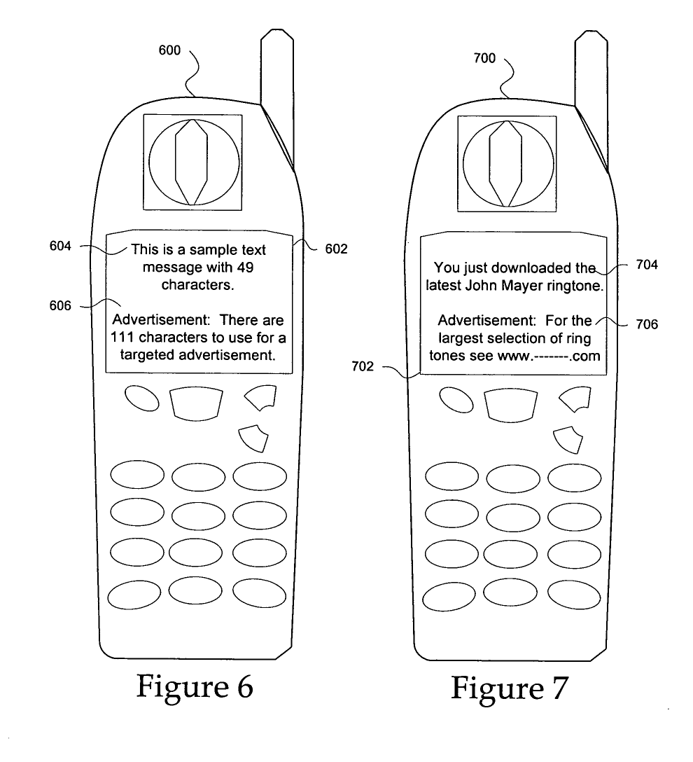

FIG. 6 illustrates one embodiment of an SMS message as would be shown on a mobile device 600. In particular, mobile device 600 includes a display 602 which displays received messages, such as the exemplary message 604 shown in the figure. The exemplary message 604 also includes an advertisement 606. The advertisement 606 illustrates that there are 111 available characters because the message is 49 characters long (160−49=111). This is assuming that a maximum length of an SMS message to be 160 characters. In alternate embodiments, the message may not be an SMS message and the maximum length may be longer or shorter. Alternatively, the limitations of the message may not be character length, but may include the amount of data, or the length or width of an advertisement. For example, a message that also displays graphics/images may allow for an advertisement that is an image or logo, but the size may be limited by the message contents and/or the screen size or amount of data in the message. For example, a message may be limited to 50 kilobytes or another amount.

Referring back to FIG. 4, in block 406, various factors are reviewed and analyzed to find an advertisement that correlates with at least a portion of those factors. The factors may include the details about the sender, recipient, and/or message that are used to target an advertisement. In one embodiment, the advertisement is targeted to the recipient of the message, therefore, the factors relate to the recipient of the message. The factors may also be referred to throughout this disclosure, including the claims, as parameters, considerations, information, data, history, and/or variables.

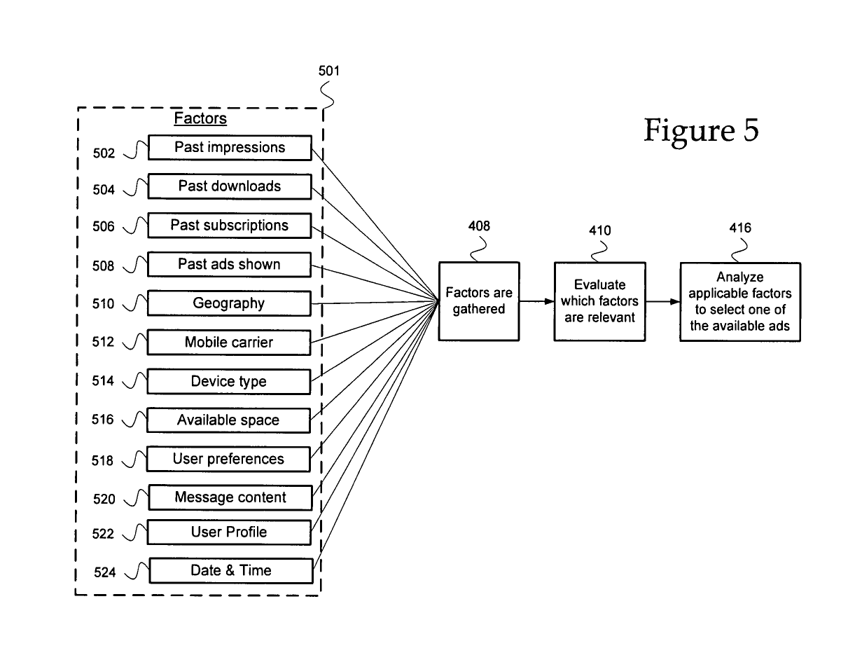

FIG. 5 depicts exemplary factors 501 which may be used, individually or in combination, for advertisement selection. In particular, some or all of the factors 501 may be considered to determine which advertisement is most relevant to the recipient. The recipient is the user who receives and will read the message including the advertisement. As described below, the factors 501 may relate to the recipient's mobile device, such as mobile device 108. In an alternative embodiment, the factors 501 may be relevant for users that are not using a mobile device, but are using a PC or other non-mobile device for messaging. In alternate embodiments, not all the factors 501 may be relevant, or there may be additional factors 501 that may be considered. The additional factors 501 may include any information or data related to the recipient.

Past impressions 502 may be one of the factors 501. Past impressions 502 may include any of the viewing habits of the recipient. In particular, any web browsing may be utilized to determine the recipients interest in particular areas. For example, a recipient who browses financial sites on mobile device 108 may be targeted with an advertisement related to finance or banking.

Past downloads 504 may be one of the factors 501. Past downloads 504 may include any programs or files that are downloaded or purchased by the recipient. For example, if the recipient downloads a “John Mayer” ringtone, then an advertisement may be targeted to the recipient.

FIG. 7 illustrates one embodiment of a message and advertisement targeting a recipient based on past downloads 504. In particular, mobile device 700 includes a display 702. The display 702 includes a message 704 that is received by the recipient. The message 704 also includes an advertisement 706. The advertisement 706 is a targeted advertisement based on past downloads. In particular, advertisement 706 advertises additional ringtones for sale based on the past downloading of a ringtone by the user. Although the message 704 shown in FIG. 7 mentions the ringtone, the actual message contents may not be used in targeting an advertisement, rather it may be a prior downloading of a ringtone.

In one embodiment, a downloaded ringtone may be received by entering a message (such as TUNE 97) to a SMS short code (such as 92466). The ringtone associated with TUNE 97 is downloaded to the recipient's device. This download may then be used to target an advertisement to the recipient based on the prior download as in FIG. 7. The past downloads 504 may help identify a recipient's interests for selecting targeted advertisements. Other examples of downloads may include wallpaper, pictures, videos, or music.

Past subscriptions 506 may be one of the factors 501. Past subscriptions 506 may include a subscription to a service or products. For example, a recipient may subscribe to a service that provides one ringtone each month or one new wallpaper each month. Past subscriptions 506 may be related to past downloads 504 in that the subscription may be for the downloading of products.

Past advertisements shown 508 may be one of the factors 501. Past advertisements shown 508 may include the advertisements that were already attached to previous messages received by a recipient. A repeat advertisement may not be as effective as a different advertisement for each message. However, if a recipient has responded to a past advertisement 508, then that advertisement may be repeated or a similar advertisement may be targeted to the recipient.

Geography 510 may be one of the factors 501. Geography 510 may include the location of the recipient when the message is received or the regular home/billing address. In one embodiment, the geography 510 may be determine by the area code in the recipient's phone number. Advertisements may be targeted based on geography. Advertisements may be for local stores, restaurants, or events. For example, an advertisement for a Broadway show in New York may be advertised to recipients located either in New York City or New York state. Advertisements may be geographically focused based on neighborhoods, cities, states, or regions. Recipients in the Midwest may receive an advertisement for a tourist destination in Chicago, Ill.

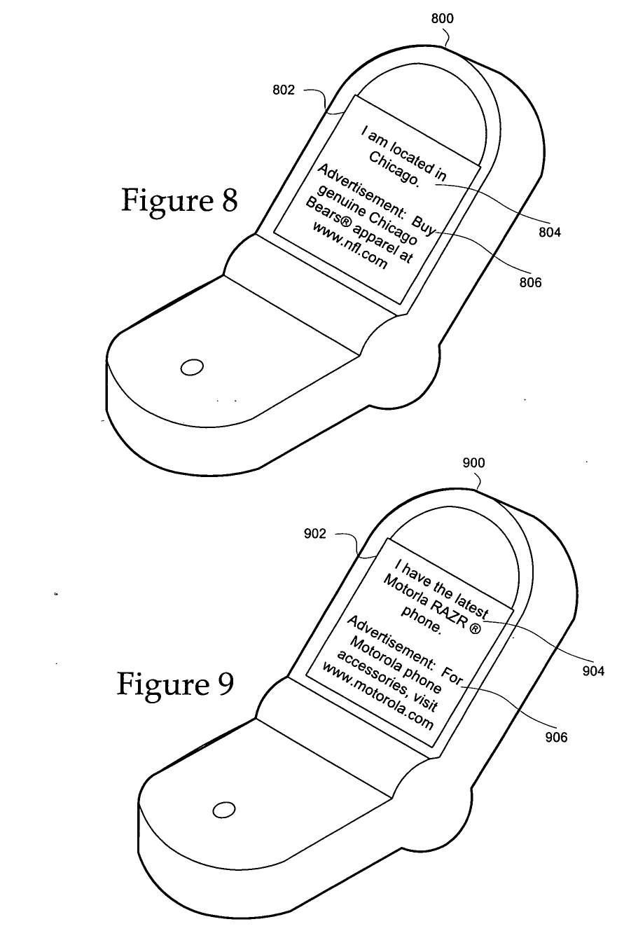

FIG. 8 illustrates one embodiment of a message 804 and advertisement 806 targeting a recipient based on geography 510. In particular, mobile device 800 includes a display 802. The display 802 includes a message 804 that is received by the recipient. The message 84 also includes an advertisement 806. The advertisement 806 is a targeted advertisement based on geography and advertises products that tend to be most popular in a particular geographic region. In particular, advertisement 806 is advertising Chicago Bears® apparel to a recipient who is located in Chicago. The message 804 may be irrelevant to the selection of this particular advertisement 806 because it is the location or geography of the recipient that resulted in the selection of this targeted advertisement.

Mobile carrier 512 may be one of the factors 501. Mobile carrier 512 may include the cellular telephone company that provides the recipient's phone service, such as the mobile carriers 110, 112 in FIG. 1. For example, Verizon®, Sprint®, and Cingular® are mobile carriers. An advertisement may be targeted based on a recipient's mobile carrier. For example, a Verizon® customer may receive a targeted advertisement relating to additional Verizon® services or products.

Device type 514 may be one of the factors 501. Device type 514 may include the brand of a mobile phone. The device type 514 may be used to target advertisements for certain phones. Specific services, products or accessories may be advertised for the particular cellular phone that a user has. For example, if the device type 514 is a Nokia 6610® phone, then all the characteristics of that phone may be known, such as whether it is GPRS enabled. Accordingly, depending on the characteristics of the phone, the targeted advertisement may be attached to the message and may be targeted to the device type 514.

FIG. 9 illustrates one embodiment of a message 904 and advertisement 906 targeting a recipient based on device type 514. In particular, mobile device 900 includes a display 902. The display 902 includes a message 904 that is received by the recipient. The message 904 also includes an advertisement 906. The advertisement 906 is a targeted advertisement based on device type 514 and advertises accessories for the particular device. In particular, advertisement 906 is advertising Motorola® phone accessories to a recipient who has a Motorola® phone. The message 904 may be irrelevant to the selection of this particular advertisement 906 because it is the device type used by the recipient that resulted in the selection of this targeted advertisement.

Available space 516 may be one of the factors 501. Available space 516 was discussed above because it may effect which advertisements may be shown. If there is a size or length limit to messages, then the length of the advertisement may be shortened based on the length of the message. Accordingly, as shown in FIG. 6 SMS messages may be limited to 160 characters, therefore the targeted advertisement may depend on the space that is available.

User preferences 518 may be one of the factors 501. User preferences 518 may include a recipient's predetermined selections regarding advertisements. In one embodiment, a recipient may opt out of receiving advertisements. Alternatively, the recipient may only receive certain types of advertisements, such as those relating only to the mobile carrier 512 or device type 514.

Message content 520 may be one of the factors 501. Message content 520 may utilize the contents of a message to select a targeted advertisement. For example, a message mentioning Britney Spears may result in a targeted advertisement for Britney Spears ringtones. However, privacy concerns may limit the use of message content 520 to only the identification of certain words in a message for a targeted advertisement. Alternatively, the message content 520 may only be considered if the user preferences 518 allow for it to be analyzed.

User profile 522 may be one of the factors 501. User profile 522 may include the user's age, sex, marital status, interests, etc. The user profile 522 may be information compiled from a variety of sources including the user's interaction wit the device. It may also be information from the cellular company that the user gave upon signing up for the cellular service.

Date and time 524 may be one of the factors 501. Date and time 524 may refer to specific dates and times when a particular advertisement is most appropriate. For example, Christmas ads may appear only during the Christmas season. Any holiday, may result in targeted advertisements related to that holiday, such as ads for costumes or candy around Halloween. Likewise, an advertisement may be targeted based on the user's birthday or other dates related to the user.

In blocks 408, 410, and 416, the factors are gathered, evaluated for relevancy, and analyzed for the selection of a targeted advertisement as discussed below. Specifically, any or all of the factors 501 may be considered in the evaluation and analysis. Alternatively, there may be other factors 501 that are related to the recipient that may be used to select a targeted advertisement.

Referring back to FIG. 4, in block 406, the factors are reviewed and analyzed to find targeted advertisements. In block 408, all the factors 501 are gathered. In particular, the factors may be data or information about the recipient that is stored in a database, such as in SMS database 216. The data may be updated for each message that is to be transmitted or each transaction by the recipient. The gathering, collecting or receiving of factors may include updating the data. In block 410, the factors are reviewed to determine which apply. For example, if the recipient has never had any past downloads, then that factor is irrelevant and does not apply. Likewise, if the recipient has not established any user preferences, then that factor is also irrelevant. Any of the factors 501 may or may not be relevant for a particular recipient receiving a particular message.

In block 412, the available advertisements are gathered or collected. A pool of potential advertisements may be stored in a database, such as the SMS database 216. The pool of advertisements may be categorized for easier reference. For example, a recipient who frequently downloads ringtones may be shown an advertisement that is categorized as ringtones-related. Accordingly, in block 414, the pool of available advertisements may be narrowed based on which advertisements may apply to a particular recipient. For example, if a recipient is located in California, then advertisements that are geographically specific to New York would not be relevant and could be excluded.

In block 416, the available advertisements are compared with the relevant factors to select at least one targeted advertisement. The applicable factors are compared with the applicable advertisements to choose a targeted advertisement. In one embodiment, the factors may be ranked according to relevance. For example, the past downloads of a recipient may be the highest ranked factor. Accordingly, the available advertisements are compared with the recipient's past downloads to select a targeted advertisement based on those past downloads. Alternatively, if there is no history for a recipient, the geography or mobile carrier may be the only factors that are considered. Advertisements that are related to either of those categories may be selected. In another embodiment, the advertisements may also be ranked in terms of priority. For example, maybe an advertisement based on geography and targeted to California recipients is a priority, such that all recipients located in California are shown that advertisement regardless of the other factors.

Accordingly, in block 406, the factors and advertisements are analyzed and compared, such that a targeted advertisement may be selected based on the analysis as in block 418. In one embodiment, each factor is analyzed individually to determine which advertisements apply to that factor. Using those advertisements, the next factor is analyzed to eliminate advertisements that do not satisfy that factor. Accordingly, this narrowing down process may be used to go through the plurality of advertisements for each factor. Alternatively, each factor may increase the pool of available advertisements rather than narrow it down by selecting which advertisements are relevant to each factor. If ten advertisements are relevant to each of three factors that are analyzed, then the pool of advertisements to choose from is 30. Accordingly, each factor may be used to narrow an initially large pool of advertisements down to those that are most relevant, or each factor may be used to build a pool of advertisements by adding each advertisement to the pool that is relevant to at least one of the factors.

In block 420, the advertisement is included with the message. The message may then be transmitted to the recipient with the advertisement that is targeted to the recipient. As described above, FIGS. 6-9 are examples showing messages with targeted advertisements.

Referring to FIG. 10, an illustrative embodiment of a general computer system is shown and is designated 1000. As described in FIG. 1 and FIG. 2, any of the components in environments 100 and 200 may be the computer system 1000 or components of the computer system 1000 as discussed below. The computer system 1000 can include a set of instructions that can be executed to cause the computer system 1000 to perform any one or more of the methods or computer based functions disclosed herein. The computer system 1000 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1004 includes a cache or random access memory for the processor 1002. In alternative embodiments, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described herein may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may further include a display unit 1014, such as a liquid crystal display (LCD), an organic light emitting diode (OLED), a flat panel display, a solid state display, a cathode ray tube (CRT), a projector, a printer or other now known or later developed display device for outputting determined information. The display 1014 may act as an interface for the user to see the functioning of the processor 1002, or specifically as an interface with the software stored in the memory 1004 or in the drive unit 1006.

Additionally, the computer system 1000 may include an input device 1016 configured to allow a user to interact with any of the components of system 1000. The input device 1016 may be a number pad, a keyboard, or a cursor control device, such as a mouse, or a joystick, touch screen display, remote control or any other device operative to interact with the system 1000.

In a particular embodiment, as depicted in FIG. 10, the computer system 1000 may also include a disk or optical drive unit 1006. The disk drive unit 1006 may include a computer-readable medium 1010 in which one or more sets of instructions 1012, e.g. software, can be embedded. Further, the instructions 1012 may embody one or more of the methods or logic as described herein. In a particular embodiment, the instructions 1012 may reside completely, or at least partially, within the memory 1004 and/or within the processor 1002 during execution by the computer system 1000. The memory 1004 and the processor 1002 also may include computer-readable media as discussed above.

The present disclosure contemplates a computer-readable medium that includes instructions 1012 or receives and executes instructions 1012 responsive to a propagated signal, so that a device connected to a network 1020 can communicate voice, video, audio, images or any other data over the network 1020. Further, the instructions 1012 may be transmitted or received over the network 1020 via a communication port 1018. The communication port 1018 may be a part of the processor 1002 or may be a separate component. The communication port 1018 may be created in software or may be a physical connection in hardware. The communication port 1018 is configured to connect with a network 1020, external media, the display 1014, or any other components in system 1000, or combinations thereof. The connection with the network 1020 may be a physical connection, such as a wired Ethernet connection or may be established wirelessly as discussed below. Likewise, the additional connections with other components of the system 1000 may be physical connections or may be established wirelessly.

The network 1020 may include wired networks, wireless networks, or combinations thereof. The wireless network may be a cellular telephone network, an 802.11, 802.16, 802.20, or WiMax network. Further, the network 1020 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for providing a targeted advertisement in a message to a recipient comprising:
receiving a request for transmitting the message to the recipient;
gathering at least one variable related to the recipient;
comparing the at least one variable related to the recipient with a plurality of advertisements to select the targeted advertisement from the plurality of advertisements; and
augmenting the message with the targeted advertisement.

2. The method according to claim 1 further comprising storing the message.

3. The method according to claim 2 further comprising transmitting the message with the augmented targeted advertisement to the recipient.

4. The method according to claim 3 wherein the message is stored temporary until the message is transmitted.

5. The method according to claim 1 wherein the message is a short message service (SMS) message.

6. The method according to claim 1 further comprising receiving the message from a mobile device of the message sender.

7. (canceled)

8. The method according to claim 1 wherein the at least one variable related to the recipient comprises at least one of past impressions, past downloads, past subscriptions, past advertisements shown, geography, mobile carrier, device type, available space, user preferences, message content, or combinations thereof.

9. A method for adding a targeted advertisement to a short messaging service (SMS) message intended for an end user comprising:
receiving information regarding the end user;
comparing the end user information with a plurality of advertisements; and
selecting the targeted advertisement from the plurality of advertisements based on the comparison with the end user information.

10. (canceled)

11. The method according to claim 9 wherein the end user information comprises at least one of past impressions, past downloads, past subscriptions, past advertisements shown, geography, mobile carrier, device type, available space, user preferences, message content, or combinations thereof.

12. The method according to claim 9 further comprising:
receiving a request for the SMS message to be sent to the end user;
storing the SMS message;
attaching the targeted advertisement to the SMS message while the SMS message is stored; and
transmitting the SMS message to the end user;
wherein the end user receives the SMS message with a mobile device.

13. The method according to claim 9 wherein the receiving information is in response to receiving a request for transmission of the SMS message to an end user.

14. The method according to claim 13 wherein the request originates from a sender, further wherein the SMS message originates from the sender.

15. In a computer readable storage medium having stored therein data representing instructions executable by a programmed processor for selecting an advertisement for a message, the storage medium comprising instructions for:
receiving a message from a sender intended for a recipient;
storing the message;
receiving a past history about the recipient;
analyzing the past history to select a targeted advertisement from a plurality of advertisements; and
augmenting the message with the targeted advertisement.

16. The storage medium according to claim 15 further comprising:
transmitting the message to the recipient; and
removing the message from storage.

17. The storage medium according to claim 15 wherein the past history comprises at least one of past impressions, past downloads, past subscriptions, past advertisements shown, or combinations thereof.

18. The storage medium according to claim 15 further comprising:
receiving at least one additional variable about the recipient; and
analyzing the at least one additional variables in the selection of a targeted advertisement from a plurality of advertisements.

19. The storage medium according to claim 18 wherein the at least one additional variable comprises geography, mobile carrier, device type, available space, user preferences, message content, or combinations thereof.

20. (canceled)

21. A system transmitting short messaging service (SMS) messages with at least one targeted advertisement, the system comprising:
a short message service center (SMSC) configured to receive and transmit the SMS messages over a network; and
a SMS database coupled with the SMSC and configured to store the SMS messages received by the SMSC; and
an advertisement server configured to attach a targeted advertisement to the SMS messages stored in the SMS database.

22. The system according to claim 21 wherein the SMS database is configured to store at least one parameter related to a user of the SMSC.

23. The system according to claim 22 wherein the SMSC is configured to receive available advertisements, such that the available advertisements are compared with the at least one parameter of a user to select the at least one targeted advertisement for the user based on the at least one parameter.

24. The system according to claim 22 wherein the at least one parameter comprises a history parameter.

25. The system according to claim 24 wherein the history parameter comprises at least one of past impressions, past downloads, past subscriptions, past advertisements shown, or combinations thereof.

26. The system according to claim 22 wherein the at least one parameter comprises at least one of past impressions, past downloads, past subscriptions, past advertisements shown, geography, mobile carrier, device type, available space, user preferences, message content, or combinations thereof.

27. (canceled)

28. A method for providing a targeted advertisement in a message to a recipient comprising:
receiving a request for transmission of the message to the recipient;
storing the message;
gathering at least one variable related to the recipient;
comparing the at least one variable related to the recipient with available advertisements to select the targeted advertisement from the available advertisements; and
attaching the targeted advertisement to the message.

29. The method according to claim 28 further comprising:
transmitting the message to the recipient; and
removing the message from storage.

30. (canceled)

31. (canceled)
